(19) United States
(12) Patent Application Publication
(10) Pub. No.: US 2016/0079015 A1
(43) Pub. Date: Mar. 17, 2016

(54) TOGGLE SWITCH FOR A PLURALITY OF SWITCHING POSITIONS

(71) Applicant: SCHALTBAU GMBH, München (DE)

(72) Inventors: Andreas BAUER, Kirchberg (DE); Heinz BAUER, Taufkirchen (DE)

(21) Appl. No.: 14/889,001

(22) PCT Filed: May 7, 2014
(86) PCT No.: PCT/EP2014/001229

§ 371 Date: Nov. 4, 2015

(30) Foreign Application Priority Data
May 7, 2013 (DE) 10 2013 007 845.8

(51) Int. Cl. H01H 21/02; H01H 21/08; H01H 21/36

(52) U.S. Cl. CPC H01H 21/025; H01H 21/36; H01H 21/085

(57) ABSTRACT

The present invention relates to a toggle switch for a plurality of switching positions, comprising a housing, a toggle lever supported on the housing and has a pivot axis, a switching cylinder supported on the housing and has a rotary axis, and a detent mechanism for catching the toggle lever in at least one switching position. The pivot axis of the toggle lever is located in the region of the housing top side with a first gear segment connected to the toggle lever and a second gear segment connected to the switching cylinder, the toggle lever and the switching cylinder engaged with each other. Light-emitting elements arranged inside the housing emit a light signal for indicating the switching position or other information. At least one element of the toggle switch is transparent, so that the light signal is emitted outwardly through the transparent element.

The present invention relates to a toggle switch for a plurality of switching positions according to the preamble of independent claim 1. A generic toggle switch comprises a housing, a toggle lever, which is supported on the housing and has a pivot axis, a switching cylinder, which is supported on the housing and has a rotary axis, and a detent mechanism for catching the toggle lever in at least one switching position, wherein the pivot axis of the toggle lever is located in the region of the housing top side and differs from the rotary axis of the switching cylinder, wherein a first gear segment is connected to the toggle lever and a second gear segment is connected to the switching cylinder, wherein the toggle lever and the switching cylinder are in engagement with each other via the first and second gear segments, and wherein the toggle switch has fastening elements for fastening the toggle switch to a control panel.

A toggle switch of the generic kind is known, for example, from DE 102008057148 B4.

Additional control instruments or display panels, respectively, are frequently used to show the operator of a toggle switch the switching position of the toggle switch or the switching status of individual switching elements that are actuated by the switching cylinder. These devices can frequently not be accommodated in the immediate vicinity of the toggle switch, for which reason it is often difficult for the operator to read the switching position and the switching states. In addition, the use of additional display devices comes with increased space requirement and sometimes entails considerable additional costs.

The object of the present invention is therefore to provide an inexpensive and space-saving solution for displaying the switching position and the switching states, respectively.

The object is satisfied by a toggle switch according to the features of independent claim 1. According thereto, the generic toggle switch then comprises a solution according to the invention when light-emitting elements are arranged inside the housing and used to emit a light signal for indicating the switching position or other information, wherein at least one element of the toggle switch, being visible to the operator of the toggle switch when the toggle switch is attached to the control panel, is transparent, so that the light signal is emitted outwardly through the transparent element.

The solution according to the invention has the advantage that no additional display devices are required to display comprehensive information to the operator of the toggle switch, in particular about the switching state of the switched elements of the toggle switch. The desired information can be read directly at the toggle switch, which greatly facilitates operation of the device. Due to the fact that the light-emitting elements are disposed inside the housing, they are effectively protected from being damaged. The light is emitted through at least one transparent element of the toggle switch. A component of the toggle switch that is needed anyway can be used for this. Therefore, no additional parts are required.

Advantageous embodiments of the present invention are the object of the dependent claims.

The toggle switch preferably has at least one switching function for switching current and/or voltage. A switching function can be either closing or opening an electric circuit as well as short circuiting a circuit to trigger a pulse for actuating a downstream switching function.

The toggle switch comprises at least one switching element that is actuated by the switching cylinder. The switching element is preferably a micro-switch. The one or more micro-switches are further preferably attached at a side wall of the housing located parallel to the switching cylinder. The switching cylinder preferably comprises a plurality of cam disks for actuating the switching elements.

Moreover, the toggle switch preferably comprises terminals for connecting the switching elements and the light-emitting elements.

The detent mechanism of the toggle switch can be configured such that the toggle lever catches in a plurality or in each of the possible switching positions, or jumps back to a neutral switching position after its actuation.

The light signals are preferably emitted to indicate the switching position, in particular to indicate the switching state of the switching elements and/or to indicate the effect of the switching states in the active circuit and/or to indicate other information and/or to illuminate the toggle switch at night.

It is in a particularly preferred embodiment of the present invention provided that all functional elements of the toggle switch except for the toggle lever are accommodated in the housing, where the housing complies with protection class IP40. The toggle switch is then particularly robust. The components of the toggle switch accommodated in the interior of the housing, in particular the light-emitting elements, are in this embodiment effectively protected against external influences, in particular against being damaged.

The toggle switch preferably corresponds to protection class IP20/40. The operator of the toggle switch cannot look into the housing itself. It is in the assembled state of the toggle switch located below the control panel. Only the toggle lever and the terminals preferably arranged on terminal strips, which are incidentally not part of the functional elements of the toggle switch, establish a connection between the housing interior and the surrounding. The housing is preferably made of plastic so that the toggle switch can be operated without grounding.

It is according to a further preferred embodiment of the present invention provided that the transparent element is a bearing in which the pivot axis of the toggle lever is mounted. No additional components are thereby required to direct the light signals toward the exterior. The light signals are particularly easy to read when the bearing has a ring-shaped upper edge visible to the operator. The ring-shaped edge surrounds the toggle lever in the region of the bearing. The light signals can then be read especially well when operating the toggle lever.

The bearing is further preferably a bearing sleeve provided as a separate component and inserted into the housing in the region of the housing top side. Such bearing sleeve can be easily and inexpensively manufactured and simplifies assembly of the toggle switch. The bearing is further preferably inserted into a hollow-cylindrical fastening projection of the housing. The bearing is preferably made of plastic so that no grounding is required for the toggle switch.

A seal is further preferably provided below the ring-shaped upper edge. Ingress of moisture into the housing of the toggle switch is therewith prevented. The seal is preferably inserted into a circumferential groove of the bearing. It seals the pivot axis of the toggle lever against the bearing.

In a further preferred embodiment of the present invention, the transparent element is the pivot axis of the toggle lever. Also in this embodiment, no additional components are required to direct the light signals toward the exterior. The readability of the light signals is then further improved where both the bearing of the toggle lever as well as the pivot axis of the toggle lever are formed as transparent elements. The pivot axis of the toggle lever can of course only be used for further transmitting the light signals if it is at least in part visible to the operator. It is for this purpose preferably formed spherically.

Both the pivot axis as well as the bearing of the toggle lever preferably ensure selective guidance of the light signal toward the exterior.

It is in a further particularly preferred embodiment of the present invention provided that the light-emitting elements are arranged on a carrier plate. The light-emitting elements can thereby easily be positioned precisely in the housing of the toggle switch. The light-emitting elements are preferably LEDs. They can be accommodated in the housing and possibly on the carrier plate in a particularly space-saving manner.

The light-emitting elements are particularly preferably arranged in a ring shape on the carrier plate. It can thereby be arranged relatively close to the bearing of the toggle lever and thus relatively close to the housing top side, whereby also the light-emitting elements arranged on the carrier plate are positioned relatively close to the housing top side. The light signals emitted by the light-emitting elements are then particularly well recognizable and readable. The carrier plate is preferably positioned directly below the ring-shaped upper edge of the bearing. The carrier plate is further preferably exchangeably received in the housing. It can thereby be very easily replaced, depending on customer needs.

Particularly simple assembly of the toggle switch is obtained when the carrier plate is received in a seat of the bearing preferably configured as a bearing sleeve.

It is in a further particularly preferred embodiment of the present invention provided that the transparent element is made of polycarbonate and comprises pigmentation, so that the light signal is emitted uniformly through the transparent element.

It is in a further particularly preferred embodiment of the present invention provided that the light-emitting elements are configured in a redundant manner and/or are connected in a redundant manner. A particularly high level of reliability of the light-emitting elements is thereby ensured.

The light-emitting elements can in a further preferred embodiment of the present invention be dimmed. The light signals can thereby firstly be adjusted to the brightness of the surroundings. In addition, this results in a greater variety of possible light signals.

It is in a further particularly preferred embodiment of the present invention provided that the color and/or the position—if a plurality of light-emitting elements are arranged in different positions and the different positions are visible to the operator—and/or the intensity and/or the frequency of the light signal can be configured depending on the information to be indicated. The light signals can thereby be adjusted according to customer need or request.

It is in a further particularly preferred embodiment of the present invention provided that the housing is composed of two half-shells into which all bearings and seats necessary for mounting the functional elements of the toggle switch are integrated. This results in a particularly simple assembly of the toggle switch according to the invention.

The seats include in particular the seat for the bearing of the toggle lever which is preferably configured as a bearing sleeve. The half-shells in particular comprise corresponding bores for receiving screws with which the housing is screwed together. The bores can preferably also be closed by blind caps made of plastic. The toggle switch can thereby be operated without grounding. The blind caps preferably firstly secure the screws, with which the housing is screwed together, in particular against being touched, and at the same time serve to fasten fastening elements which are needed for mounting the toggle switch to a control panel. For example, spring clips can be attached to the blind caps that support the toggle switch against the underside of the control panel.

The two half-shells of the housing are further preferably sealed against each other by a seal. The seal is received preferably in a groove in at least one of the two half-shells.

It is in a further preferred embodiment of the present invention provided that the terminals for connecting the switching elements and possibly the light-emitting elements are arranged on the underside of the housing. Connecting the toggle switch according to the invention is thereby facilitated.

The switching cylinder is in a further particularly preferred embodiment of the present invention mounted rotatably on either side in the housing by use of a bearing, where one of the two half-shells of the housing has an opening for receiving a bearing insert that is visible from the outside and in which the first bearing is fixed and covered to protect the functional elements of the switch accommodated in the housing against the ingress of moisture and therefore to comply with protection class IP40. Mounting the switch is in this embodiment facilitated. The bearing insert is preferably made of plastic and is further preferably configured to be red. Due to the red color, the technician can easily recognize how the toggle switch is to be properly aligned during assembly. Further preferably, the German figurative mark no. 480981 of Schaltbau GmbH is applied centrally on the surface of the bearing insert visible from the exterior. The bearing insert further preferably has a spacing of at least 25% of the total width or total height of the housing to the outer edge of the first half-shell of the housing. This allows for particularly easy and reliable mounting of the toggle switch. The second bearing of the switching cylinder is further preferably supported inside in the other of the two half-shells, not visible from the outside, and positioned such that the switching cylinder extends parallel to the side walls of the housing.

It is in another embodiment of the present invention provided that the half-shells of the housing have seats for receiving carrier plates for the switching elements of the toggle switch, where the seats taper towards the outer walls of the half-shells. This facilitates assembly of the carrier plates for the switching elements.

It is in a further preferred embodiment of the present invention provided that the switching angle or the deflection of the toggle lever, respectively, is restricted by locking pins which can be inserted into plastic sleeves of one of the two half-shells. The locking pins preferably interact with the gear segment of the toggle lever. The locking pins further preferably experience a counter bearing by the plastic rings provided in the second half-shell and are thereby mechanically stabilized.

In another embodiment of the present invention, a biasing spring provided for the detent mechanism is secured against displacement by a projection attached to one of the two half-shells.

In a further preferred embodiment of the present invention, the gear ratio between the deflection of the toggle lever and the rotation of the switching cylinder can be adjusted by the spacing between the first or the second gear segment, respectively, relative to the pivot axis of the toggle lever or respectively the rotary axis of the switching cylinder.

Further preferably, the German figurative mark no. 2050523 is applied on the outside of one of the two half-shells of the housing.

For mounting of the toggle switch onto a control panel, a fastening projection of the housing is from the rear side of the control panel inserted into an opening especially provided form this and is by use of a fastening ring mountable from the front side, preferably with a bayonet lock, supported against the front side of the control panel. Various solutions can be used for supporting the housing against the rear side of the control panel.

Tool-free installation is possible, for example, by use of special spring clips. For this purpose, a rotatable spring clip is attached to each of the two sides of the toggle switch, preferably in cylindrical seat elements provided for this on the housing or on the blind caps mentioned above. The spring clips each comprise a spring element which exerts a spring force against the rear side of the control panel when the spring clips are flipped downwardly on the respective housing side. The spring clip thereby engages in corresponding knobs of the housing and is thereby locked.

Respectively stable mounting is obtained where the toggle switch is on the housing top side provided with a special screw attachment support which on both sides of the housing comprises a pressure tongue which can be extended by use of a screw. The two pressure tongues are by tightening the respective screws pressed against the underside of the control panel so that the toggle switch is attached to the control panel and effectively secured against rotation.

Embodiments of the present invention are explained in more detail below with reference to drawings, where

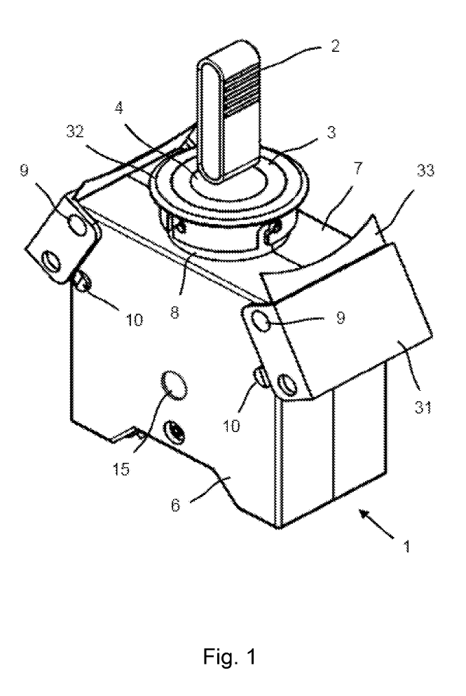

FIG. 1 shows a perspective view of a toggle switch according to the invention with spring clips for mounting the toggle switch to a control panel;

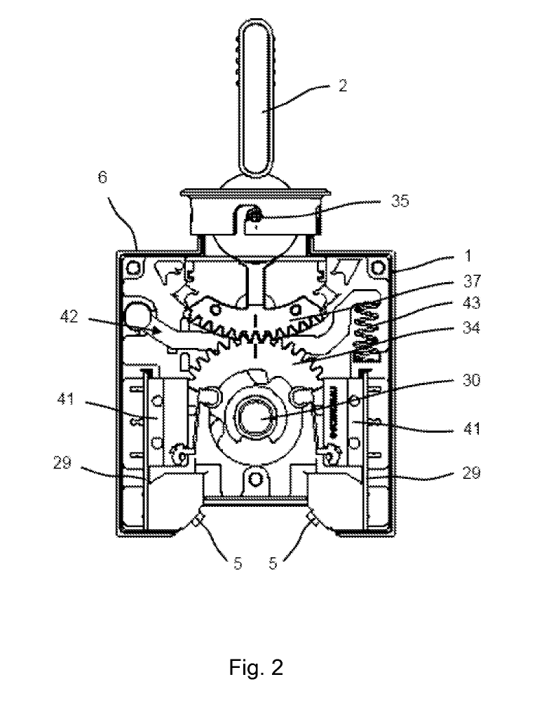

FIG. 2 shows a schematic sectional view of the toggle switch according to the invention of FIG. 1—functional representation;

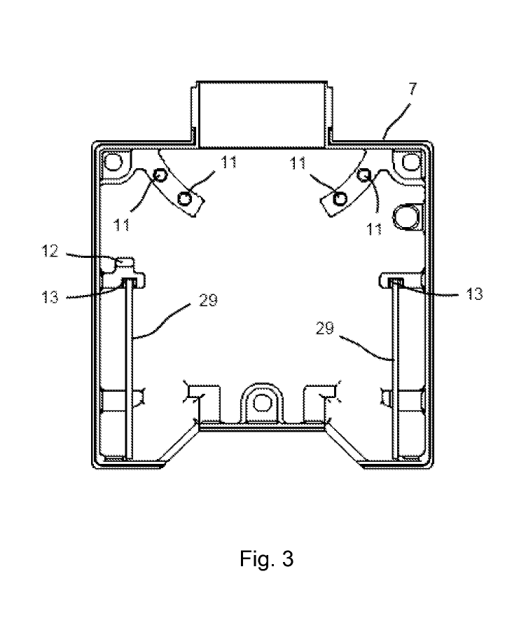

FIG. 3 shows a half-shell of the housing of the toggle switch according to the invention of FIGS. 1 and 2—interior view;

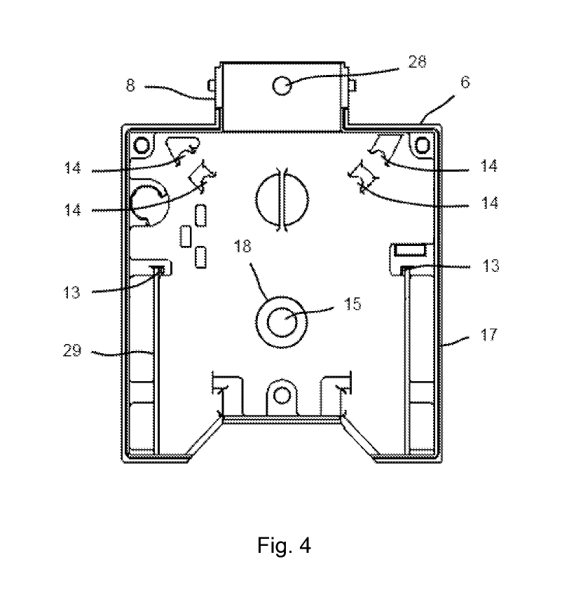

FIG. 4 shows the other half-shell of the housing of the toggle switch according to the invention of FIGS. 1 and 2—interior view;

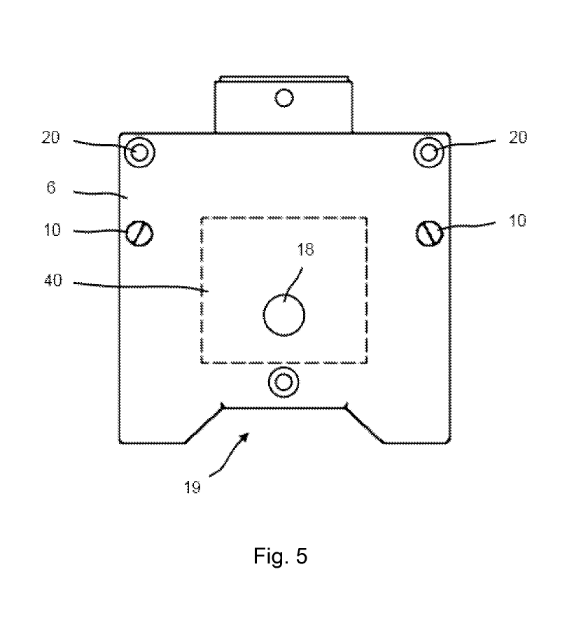

FIG. 5 shows the half-shell of the housing of FIG. 4—exterior view;

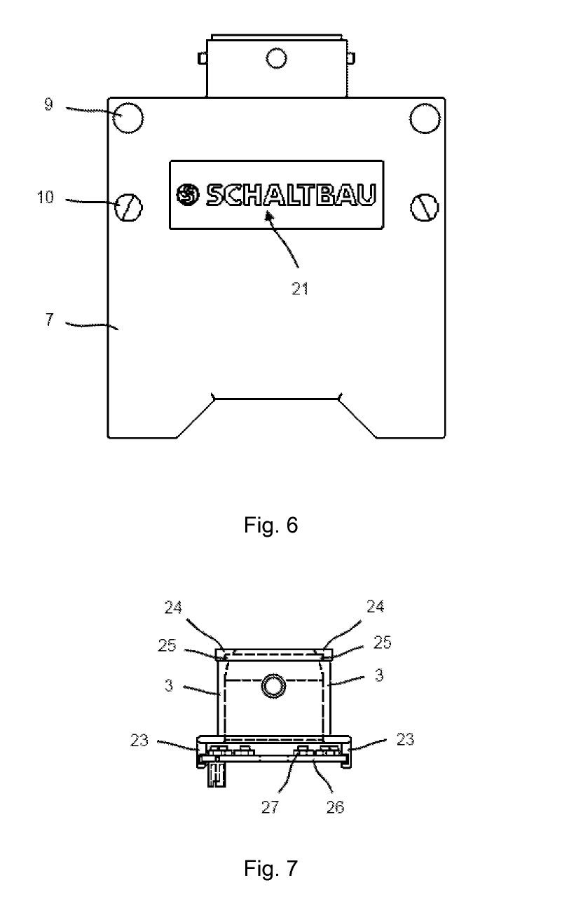

FIG. 6 shows the half-shell of the housing of FIG. 3—exterior view;

FIG. 7 shows the bearing of the toggle lever of the toggle switch according to the invention of FIGS. 1 and 2;

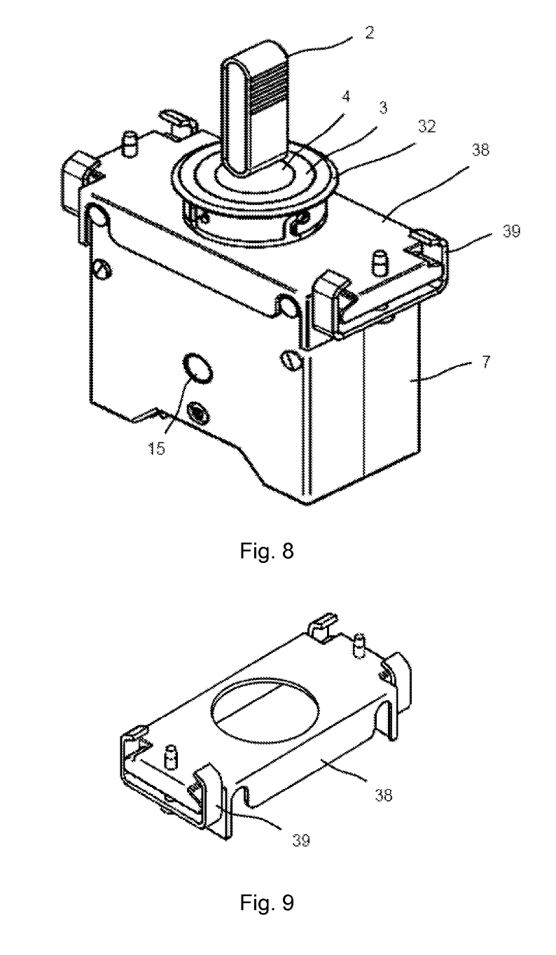

FIG. 8 shows a perspective view of a toggle switch according to the invention with a screw attachment support for mounting the toggle switch on a control panel;

FIG. 9 shows the screw attachment support of the toggle switch of FIG. 8 in detail.

It applies to the entire description that like components are designated with like reference numerals. If a drawing contains reference numerals which are not explained in detail in the accompanying figure description, then reference is made to the preceding or subsequent figure description.

FIG. 1 shows a perspective view of a toggle switch according to the invention with switch housing 1, toggle lever 2, a transparent illuminated bearing 3 of the toggle switch and a transparent illuminated and spherical rotary axis 4 of the toggle lever. Housing 1 of the toggle switch is composed of the two half-shells 6 and 7. On the housing top side, it comprises a fastening projection 8 which can be inserted from the rear side into a respective opening of a control panel. Fastening projection 8 is hollow-cylindrical and receives bearing 3 of toggle lever 2. Spring clips 31 and fastening ring 32 with a bayonet lock are used to fasten the toggle switch to the control panel, not shown. It is mounted from the front side of the control panel to fastening projection 8 and thereby supports the toggle switch against the front side of the control panel. A rotatable spring clip 31 is respectively fastened on either side of the toggle switch, namely, on blind caps 9 provided for this, whose function shall be explained further below. Spring clips 31 each comprise a spring element 33 which exerts a spring force against the rear side of the control panel when the spring clips are flipped downwardly on the respective housing side. The spring clips thereby engage in corresponding knobs 10 of the housing and are thereby locked.

FIG. 2 shows the internal structure of the toggle switch in a schematic representation. Axis 35 of the toggle lever in the housing top side and the switching cylinder 30 disposed therebelow within the housing for actuating a plurality of switching elements (micro-switches) 41 are visible. They are attached on either side of the housing to corresponding carrier plates 29. Toggle lever 2 and switching cylinder 30 are in engagement via two gear segments 34, 37 so that a movement of the toggle lever is converted into a movement of the switching cylinder. Gear segment 34 is there connected to the switching cylinder, gear segment 37 on the other hand to the toggle lever. Further visible are detent mechanism 42 - only schematically illustrated—of the toggle switch for engaging the toggle lever in the intended switching position and spring 43 of the detent mechanism. Terminals 5 in the form of terminal strips attached to carrier plates 29 are also visible at the housing underside.

FIG. 3 shows half-shell 7 from the interior. It comprises integrated plastic sleeves 11 for receiving locking pins which restrict the deflection of the toggle lever as required. Projection 12 shown at the left is used to secure biasing spring 43, In addition, seats 13 for carrier plates 29 of the switching elements are shown Seats 13 taper toward the half-shell outer wall located in the drawing plane.

FIG. 4 shows the interior view of half-shell 6 with plastic counter bearings 14 integrated into the half-shell for supporting the above-mentioned locking pins after assembly of the housing. A bearing insert 15 for one of the two bearings of the switching cylinder is inserted into an opening 18 in the bearing insert provided for this. A bore 28 is visible at attachment projection 8 for the axis of the toggle lever. The figure also shows that a groove is formed at the edge of the half-shell for realizing a seal 17 with which the two half-shells are sealed against the ingress of moisture.

FIG. 5 shows half-shell 6 from the exterior. A bottom recess 19 of the housing is drawn in, on the inclined sides of which the terminal strips 5 are arranged. The figure also shows bores 20 for screws with which the housing is screwed together. Also shown is region 40 in which opening 18 for the bearing insert of the switching cylinder is preferably to be located.

FIG. 6 shows an exterior view of half-shell 7. The bores shown in FIG. 5 are in this illustration closed by blind caps 9. The blind caps, as already mentioned, are used for attaching spring clips 31. It is further shown that the figurative mark 21 “Schaltbau” is applied on the outside of half-shell 7.

FIG. 7 in detail shows transparent bearing 3 of toggle lever 2 already indicated in FIG. 1. The bearing is configured as a separate bearing sleeve. The ring-shaped upper edge of the bearing being only directly visible from the outside in the fully assembled state is in the illustration provided with reference numeral 24. Groove 25 is provided immediately below ring-shaped edge 24 for introducing a sealing ring with which the housing is sealed against moisture. Seat 23 for a carrier plate 26 is formed at the bottom end of the bearing sleeve. Light-emitting elements 27 in the form of LEDs provided according to the invention are arranged in ring shape on carrier plate 26.

FIG. 8 shows a further embodiment of a toggle switch according to the invention which substantially corresponds to the embodiment of FIGS. 1 to 7. In deviation from the first embodiment, the toggle switch is on the housing top side provided with a special screw attachment support 38. It comprises a pressure tongue 38 on either side of the housing which can be extended by use of a screw. The two pressure tongues 39 are by tightening the respective screws pressed against the underside of the control panel—not shown—so that the toggle switch is attached to the control panel and effectively secured against rotation.

FIG. 9 shows screw attachment support 38 in detail.

1-15. (canceled)

16. A toggle switch for a plurality of switching positions, comprising a housing (1), a toggle lever (2), which is supported on said housing and has a pivot axis (4), a switching cylinder (30), which is supported on said housing and has a rotary axis, and a detent mechanism (42) for catching said toggle lever in at least one switching position, wherein said pivot axis of said toggle lever is located in the region of the housing top side and differs from said rotary axis of said switching cylinder, wherein a first gear segment (37) is connected to said toggle lever and a second gear segment (34) is connected to said switching cylinder, wherein said toggle lever and said switching cylinder are in engagement with each other via said first and second gear segments, and wherein said toggle switch has fastening elements (32, 31; 39) for fastening said toggle switch to a control panel wherein light-emitting elements (27) are arranged inside said housing and used to emit a light signal for indicating the switching position or other information, wherein at least one element (3, 4) of said toggle switch, being visible to the operator of said toggle switch when said toggle switch is attached to said control panel, is transparent, so that said light signal is emitted outwardly through said transparent element (3, 4), wherein said transparent element is a bearing (3) in which said pivot axis (4) of said toggle lever (2) is mounted.

17. The toggle switch according to claim 16, wherein all functional elements of said toggle switch except for said toggle lever (2) are accommodated in said housing (1), where said housing complies with protection class IP40.

18. The toggle switch according to claim 16, wherein said bearing (3) has a ring-shaped upper edge (24) visible to the operator.

19. The toggle switch according to claim 18, wherein a seal (25) is provided below said ring-shaped upper edge (24).

20. The toggle switch according to claim 16, wherein said pivot axis (4) of said toggle lever (2) is also a transparent element.

21. The toggle switch according to claim 16, wherein said light-emitting elements (27) are arranged on a carrier plate (26).

22. The toggle switch according to claim 21, wherein said light-emitting elements (27) are arranged in a ring shape on said carrier plate (26).

23. The toggle switch according to claim 21, wherein said carrier plate (26) is received in a seat (23) of said bearing (3).

24. The toggle switch according to claim 16, wherein said transparent element (3, 4) is made of polycarbonate and comprises pigmentation, so that said light signal is emitted uniformly through said transparent element.

25. The toggle switch according to claim 16, wherein said light-emitting elements (27) are configured in a redundant manner and/or are connected in a redundant manner.

26. The toggle switch according to claim 16, wherein said light-emitting elements (27) can be dimmed.

27. The toggle switch according to claim 16, wherein the color and/or the position and/or the intensity and/or the frequency of said light signal can be configured depending on the information to be indicated.

28. The toggle switch according to claim 16, wherein said housing (1) is composed of two half-shells (6, 7) into which all bearings and seats necessary for mounting said functional elements of said toggle switch are integrated.

29. The toggle switch according to claim 28, wherein said switching cylinder (30) is mounted rotatably on either side in said housing (1) by use of a bearing, wherein one of said two half-shells (6, 7) of said housing has an opening (18) for receiving a bearing insert (15) that is visible from the outside and in which said first bearing is fixed and covered to protect said functional elements of said switch accommodated in said housing against the ingress of moisture and therefore to comply with protection class IP40.
